(19) United States
(12) Patent Application Publication
(10) Pub. No.: US 2026/0287308 A1
(43) Pub. Date: Sep. 24, 2026

(54) Optic Devices with Multiple Ballistic Profiles And Methods of Switching Between Ballistic Profiles

(71) Applicant: GUNWERKS, LLC, Cody, WY (US)

(72) Inventors: Aaron DAVIDSON, Cody, WY (US); Haizhou LI, Austin, TX (US)

(73) Assignee: GUNWERKS, LLC, Cody, WY (US)

(21) Appl. No.: 19/085,687

(22) Filed: Mar. 20, 2025

(51) Int. Cl. F41G 3/08; F41G 3/16; G02B 27/01

(52) U.S. Cl. CPC F41G 3/08; F41G 3/165; G02B 2027/0178

(57) ABSTRACT

An optic device can include: an eyepiece having a field of view through one or more lenses; a display element configured to present a graphical user interface viewable through the eyepiece at a position adjacent to or overlaid relative to the field of view; an input element receptive to user input; a processor; and a memory device. The memory device can include computer-executable instructions that, when executed by the processor, cause the optic device to: receive multiple zero angle profiles from a client device; identify a user input via the input element to select one of the zero angle profiles; and generate, for display in the graphical user interface, a ballistic solution according to the selected zero angle profile.

### FIELD

The described examples relate generally to optic devices. In particular examples, the present disclosure relates to optic devices that can store, use, and switch between multiple ballistic profiles.

### BACKGROUND

Certain optic devices (e.g., scopes) can be mounted on guns, crossbows, and other devices to aid a user's perception of a target. Other optic devices (e.g., rangefinders, rangefinding binoculars, spotting scopes, etc.) can be used independent of a firearm. In any case, optic devices can help a user perceive a target positioned tens, hundreds, or even over a thousand yards away from the user.

Merely perceiving a target through the scope is insufficient for an accurate shot. In particular, projectiles (e.g., a bullet, ball, arrow, pellet, slug, buckshot, etc.) will often travel a path that is non-linear as the projectile travels in the air over a distance toward the target. In other terms, the projectile will be subject to the effects of gravity, wind, and other factors (e.g., elevation, pressure, temperature, etc.) such that the projectile does not travel in a straight line from the user to the target.

Optic devices can include mechanisms to account for these effects. For ordinary optical rifle scopes, adjustments for bullet trajectory are made through mechanical adjustment of the optical assembly (e.g., to adjust an angle of the optical assembly relative to the rifle barrel). For example, an elevation turret on an optical scope can be used to compensate or adjust for an amount of vertical drop that a projectile will undergo at a given distance to an intended target. Similarly, a windage turret on a scope can be used to compensate or adjust for an amount of horizontal variance that a projectile will undergo at a given distance to an intended target (e.g., due to wind conditions). To illustrate, a user can turn an elevation turret on a scope a certain number of clicks (e.g., that correspond to minutes of angle or milliradians) to adjust the optical system of the scope so that crosshairs or another visual indicator of the scope reticle aligns with a true point of impact where the projectile will strike the intended target.

The amount of adjustment depends on myriad different factors. Environmental factors mentioned above and projectile-specific factors can affect trajectory. For instance, a trajectory for a bullet shot from a rifle or other firearm (e.g., pistol, muzzleloader, etc.) can be affected by elements of a ballistic profile, such as the bullet shape and weight, ammunition load (e.g., grain), muzzle velocity, drag coefficient, spin drift, etc. As another example, broadhead weight and type, arrow shaft weight, and fletching can affect the trajectory of an arrow. Other types of factors are not expressly environmental, but may nonetheless be an external factor to account for in terms of trajectory adjustment (e.g., Coriolis drift, vertical (Eötvös) effect, Magnus effect, Poisson effect, location-specific gravity, etc.).

Certain devices can be utilized to determine the amount of adjustment given the above-mentioned factors. For example, binoculars, range finders, scopes, mobile devices, etc. can implement hardware and/or software to determine the amount of angular adjustment for a particular ballistic profile, distance to a target, and/or set of environmental factors. Additionally or alternatively, some product manuals (e.g., for a firearm or ammunition) and ballistic calculators can provide a recommended adjustment for certain factors. The amount of adjustment can also be mechanically set or zeroed at a predetermined target distance (e.g., 200 yards away) so that crosshairs or another visual indicator of the scope reticle aligns with a true point of impact at that predetermined target distance. After setting the mechanical zero of a scope, targets positioned at a different distance (e.g., 1000 yards away) rather than the zero distance (e.g., 200 yards away) will require turret adjustment to account for the new target positioning. Specifically, based on a ballistic profile that ballistically calculates projectile path, a user can implement the profile-indicated adjustment via a corresponding number of clicks or turns at a turret on the scope.

Often, however, situational circumstances change that can lend to an inaccurate shot. Extreme shifts in environmental conditions are a common occurrence (e.g., when hunting in a different state or even with significant elevation change on a mountain for instance). In another example, sometimes a user may need to shoot a different type of ammunition (e.g., lead-free bullets as presently required in California) or a different load/lot of ammunition. In some cases, a user may wish to use a suppressor on one hunting trip, but then remove the suppressor thereafter. Over time, a rifle barrel can also wear. These and many other scenarios can significantly alter the accuracy of a calculated ballistic adjustment (e.g., an indicated MOA or MRAD adjustment on the turret) so that, especially at longer ranges, the projectile impact will likely miss the intended target. Indeed, the foregoing example scenarios can effectively nullify a ballistic solution provided according to a set ballistic profile such that users would typically have to re-zero their optic device to again attain shot accuracy according to a new ballistic solution. However, re-zeroing is not only time consuming and inconvenient, sometimes it is not practical or even possible to do based on the circumstances.

In certain exacerbating situations, some scopes have ballistic data rings (custom turret markings) that are calibrated to achieve a predetermined amount of adjustment given the initial zeroing conditions. Thus, the accuracy of custom ballistic data rings can be entirely voided when any one of a variety of factors (e.g., environmental conditions, firearm data, ammunition data, or firearm configuration) differs from the initial zeroing conditions that existed when the ballistic data ring was manufactured. In such situations, the firearm is typically sent back to the manufacturer for generating a replacement ballistic data ring calibrated to the new shooting conditions. The inconvenience and impracticality of this arrangement is clear. Accordingly, there is an ongoing need for improved optic devices that can store and dynamically (e.g., on the fly in real time or near real time) switch between multiple ballistic profiles to conveniently and accurately account for variation in shooting conditions, firearm performance, ammunition data, and/or firearm setup—all without creating a new ballistic data ring for the turret or re-zeroing (i.e., changing the mechanical zero of) the optic device.

The subject matter claimed herein is not limited to examples that solve any disadvantages or that operate only in environments such as those described above. Rather, this background is only provided to illustrate one example technology area where some examples described herein may be practiced.

### SUMMARY

An aspect of the present disclosure relates to a method. The method can include identifying a zero range ballistic profile for use with a pre-configured ballistic turret having custom markings, the pre-configured ballistic turret being pre-configured according to a set of zeroing environmental conditions, a first set of firearm data, a first set of ammunition data, and a first firearm configuration. The method can additionally include identifying a zero angle ballistic profile associated with at least one of: a set of shooting conditions different than the set of zeroing environmental conditions; a second set of firearm data different than the first set of firearm data; a second set of ammunition data different that the first set of ammunition data; or a second firearm configuration different than the first firearm configuration. The method can additionally include determining, using the zero angle ballistic profile and the zero range ballistic profile, a zero angle ballistic solution that includes an effective distance to a target in relation to the custom markings on the pre-configured ballistic turret.

In some examples, the first firearm configuration or the second firearm configuration differ from each other by at least one of a suppressor, a support stand setup, a firearm weight, or a scope height. In some examples, the first firearm data and the second firearm data differ from each other by at least one of a caliber, a barrel length, a barrel twist rate, or a twist direction. In some examples, the first set of ammunition data and the second set of ammunition data differ from each other by at least one of a muzzle velocity, a bullet weight, a bullet length, or a ballistic coefficient. In some examples, the set of zeroing environmental conditions and the set of shooting conditions differ from each other by at least one of elevation, pressure, air density, temperature, humidity, azimuth, incline, or wind conditions.

In one or more examples, determining the zero angle ballistic solution comprises: determining, for the zero range ballistic profile, a reference angle between a line of sight for an optic device and a bore line of the firearm, wherein the reference angle positions a theoretical projectile path to intersect the line of sight at a reference distance to the target for the set of zeroing environmental conditions; determining, for the zero angle ballistic profile, an actual angle between the line of sight and the bore line, wherein the actual angle positions a projectile path to intersect the line of sight at a ranged distance to the target; and determining the effective distance to the target based on the actual angle and the reference angle.

In certain examples, determining the effective distance to the target comprises iteratively modifying the reference distance to the target until the reference angle approximates the actual angle within a threshold value. In at least one example, determining the effective distance to the target comprises interpolating the reference angle and the actual angle. In some examples, determining the zero angle ballistic solution comprises converting a zero angle ballistic drop compensation value for the zero angle ballistic profile to a turret value found on the custom markings according to the zero range ballistic profile, the turret value comprising a distance value represented in yards, meters, or other calibration scale.

Another aspect of the present disclosure relates to a system. The system can include a first optic device mountable on a firearm and configurable to a mechanical zero setting. The system can additionally include a client device having: a ballistic profile established for the firearm and the first optic device configured at the mechanical zero setting; and a modified ballistic profile also established for the firearm and the first optic device configured at the mechanical zero setting, the modified ballistic profile being related to the ballistic profile via at least a point of impact differential. The system can additionally include a second optic device communicatively coupled to the client device and comprising: a processor; and a memory device. The memory device can include computer-executable instructions that, when executed by the processor, cause the second optic device to: receive, via a network connection to the client device, the ballistic profile and the modified ballistic profile; generate, for display in a graphical user interface, a selection menu comprising the ballistic profile and the modified ballistic profile; identify a first user input selecting the modified ballistic profile from the selection menu; and generate, for display in a graphical user interface, a first ballistic solution according to the modified ballistic profile.

In some examples, the ballistic profile and the modified ballistic profile are both zero angle ballistic profiles. In one example, the ballistic profile and the modified ballistic profile both account for respective environmental conditions existing when the ballistic profile and the modified ballistic profile were created. In certain examples, the first optic device comprises a pre-configured ballistic turret having custom markings; and the first ballistic solution comprises an effective distance to a target in relation to the custom markings on the pre-configured ballistic turret. In particular examples, the second optic device can: identify a second user input within the selection menu to switch from the modified ballistic profile to the ballistic profile; and generate, for display in the graphical user interface, a second ballistic solution according to the ballistic profile.

In some examples, the ballistic profile and the modified ballistic profile differ by at least one of environmental conditions, firearm data, ammunition data, or firearm configuration. In one example, the point of impact differential comprises a difference in elevation offset values respectively measured for bullet impacts according to the ballistic profile and the modified ballistic profile on a target positioned at a known distance. In at least one example, the first optic device comprises: the ballistic profile and the modified ballistic profile stored thereon; a turret; an eyepiece; and a heads up display viewable through the eyepiece and configured to also display the first ballistic solution according to the modified ballistic profile by dialing the turret until a displayed ballistic solution on the heads up display matches the first ballistic solution.

Yet another aspect of the present disclosure relates to an optic device. The optic device can include: an eyepiece having a field of view through one or more lenses; a display element configured to present a graphical user interface viewable through the eyepiece at a position adjacent to or overlaid relative to the field of view; an input element receptive to user input; a processor; and a memory device. The memory device can include computer-executable instructions that, when executed by the processor, cause the optic device to: receive multiple zero angle profiles from a client device; identify a user input via the input element to select one of the zero angle profiles; and generate, for display in the graphical user interface, a ballistic solution according to the selected zero angle profile.

In some examples, the zero angle profiles are configured to generate ballistic solutions for at least one of new environmental conditions, new firearm data, new ammunition data, or a new firearm configuration; and the ballistic solutions are displayable in terms of custom markings of a pre-configured ballistic turret established according to an original set of zeroing environmental conditions, an original set of firearm data, an original set of ammunition data, and an original firearm configuration. In certain examples, each of the zero angle profiles assumes a constant mechanical zero setting that is unchanged regardless of which zero angle profile is selected.

Other technical features may be apparent to one skilled in the art, having the benefit of this disclosure, in connection with the following figures, descriptions, and claims. Further, the subject matter claimed herein is not limited to embodiments that solve any disadvantages or that operate only in environments such as those described above. Rather, this summary section is only provided to illustrate certain feature and embodiments.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a system environment in accordance with one or more examples of the present disclosure;

FIG. 2 illustrates a schematic view of a ballistic profile used to generate a ballistic solution in accordance with one or more examples of the present disclosure;

FIG. 3 illustrates a specific schematic implementation of using a zero-angle ballistic profile in conjunction with a pre-configured ballistic turret that is associated with a zero range ballistic profile;

FIG. 4 illustrates an example schematic implementation including multiple zero angle ballistic profiles in accordance with one or more examples of the present disclosure; and

FIG. 5 illustrates a flowchart of a series of acts 500 for determining a zero angle ballistic solution in accordance with one or more examples of the present disclosure.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described examples as defined by the appended claims.

Certain embodiments of the following disclosure relate to systems and methods of implementing optic devices with multiple ballistic profiles. For example, the present disclosure provides a novel way of storing multiple ballistic profiles, including ballistic profiles of different types (e.g., zero range and zero angle). In addition, certain examples of the present disclosure enable convenient switching and/or cross-compatibility of ballistic profiles (e.g., directly within the optic device itself). For example, a rangefinder of the present disclosure can store a zero range ballistic profile corresponding to a firearm setup having scope with a pre-configured ballistic turret. In this example, a user can change their shooting setup for that firearm without voiding the usability of the pre-configured ballistic turret. To do so, a new/modified ballistic profile (e.g., a zero angle ballistic profile) can be created and ballistically related to the original zero range ballistic profile—thus facilitating continued usability of the preconfigured ballistic turret because the zero angle ballistic profile can accurately generate ballistic solutions relative to the uniquely prior-calibrated/encoded turret. In addition, because of the built-in ballistic relation between profiles, the user conveniently does not need to re-zero an optic device.

As another example, a scope, rangefinder, or other optic device can quickly and easily toggle, cycle between, or choose from among different created ballistic profiles—all in real time and directly within the optic device. In this way, the optic device can generate ballistic solutions corresponding to the actual environment or current shooting scenario (including for different firearm configurations, different firearm data, different ammunition data, etc.).

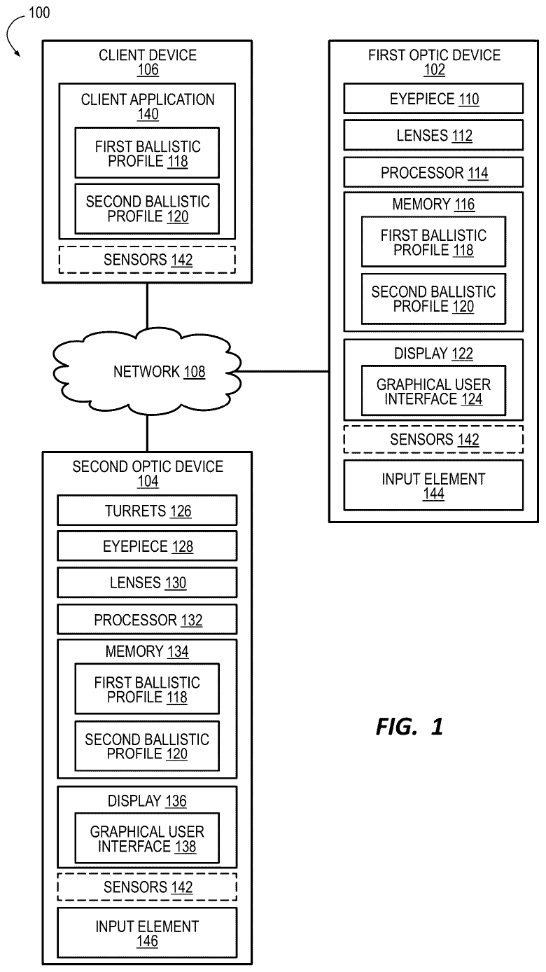

These and other examples are discussed below with reference to FIGS. 1-5. However, a person of ordinary skill in the art—having the benefit of this disclosure—will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a system environment 100 in accordance with one or more examples of the present disclosure. As shown, the system environment 100 can include a first optic device 102, a second optic device 104, a client device 106, and a network 108. Each is discussed in turn below.

The first optic device 102 can include a variety of optic devices. Examples of the first optic device 102 can include a rangefinder, binoculars (e.g., rangefinding binoculars), a spotting scope, etc. In these or other examples, the first optic device 102 can include an eyepiece 110 defined by the housing of the first optic device 102. The eyepiece 110 can be sized and shaped to retain one or more lenses 112 (e.g., ocular lenses). The eyepiece 110 can, in particular examples, allow a user to peer through the first optic device 102 and visualize a provided field of view (e.g., a live view of the environment as seen through the perspective of the first optic device 102). Distal to the eyepiece 110, the housing of the first optic device 102 can retain one or more additional lenses of the lenses 112 (e.g., objective lenses). These and other lenses of the lenses 112 can help capture ambient light and magnify a field of view. Additionally or alternatively, the lenses 112 can include form a glass seal or sensor-transparent closure such that sensors and other electronics (e.g., the processor 114 and the memory 116) disposed inside the first optic device 102 can be protected and sealed from the ambient environment.

The first optic device 102 can additionally include a processor 114. A variety of processors can be utilized. In some examples, the processor 114 can include one or more of a system on chip, integrated circuit, driver, microcontroller, application processor, crossover processor, etc.

Further, the first optic device 102 can include a memory 116. The memory 116 can include a variety of different types of memory. In some examples, the memory 116 can include one or more memory devices (e.g., individual nonvolatile memory, processor-embedded nonvolatile memory, random access memory, memory integrated circuits, DRAM chips, stacked memory modules, storage devices, memory partitions, etc.). The memory 116 can store various data, including data from other devices in the system environment 100.

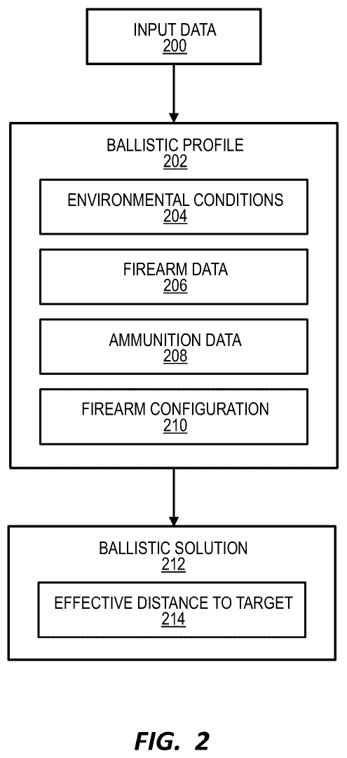

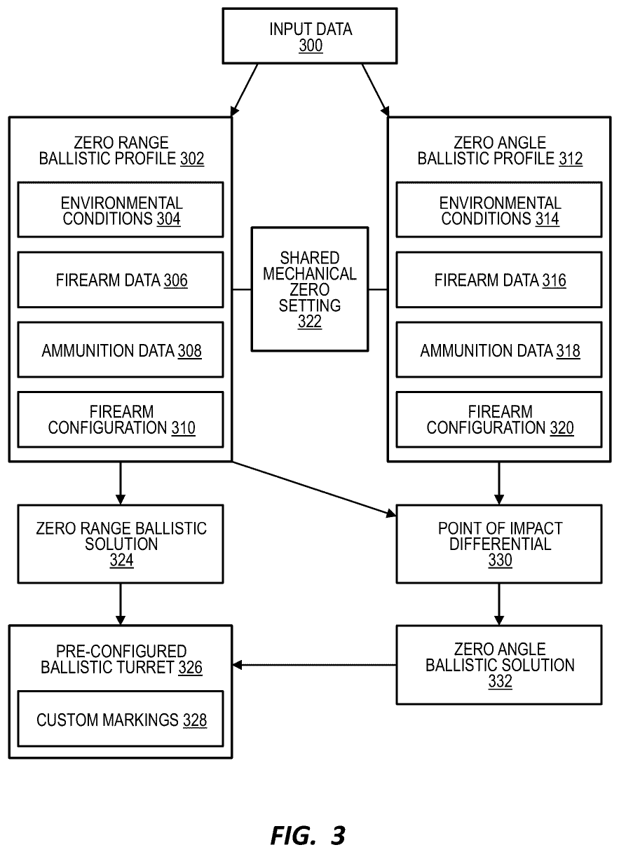

In particular examples, the memory 116 can store environmental conditions, turret settings, distance compensation data, etc. As expressly shown, the memory 116 can include a first ballistic profile 118 and a second ballistic profile 120 different than the first ballistic profile 118. The elements of a ballistic profile are discussed in detail below in relation to FIG. 2. In general, however, a ballistic profile can include a precise ballistic recipe of settings and configurations in relation to the environment, firearm, and ammunition that lends to an accurate, real-time calculation with built-in ballistic adjustment (e.g., ballistic drop compensation) to hit a target downrange. Unlike conventional optic devices, the first optic device 102 can store multiple ballistic profiles and dynamically switch between them without necessitating an optic device (e.g., the optic device 104) mounted on the firearm to be mechanically re-zeroed—as will be discussed more in relation to FIG. 3). Thus, despite changes or deviations from the first ballistic profile 118 (for instance), the first optic device 102 can seamlessly (i.e., on the fly within a matter of seconds) switch to the second ballistic profile 120 corresponding to the new ballistic recipe.

Through the eyepiece 110, a user can view a display 122 disposed inside the housing of the first optic device 102. In particular examples, the display 122 includes a digital display that can generate a graphical user interface 124. The graphical user interface 124 can include various information such as a ballistic profile selection (e.g., “PROFILE B”), connectivity information (e.g., a BLUETOOTH® signal connection, a paired device connection, etc.), a battery life indicator representing an amount of remaining battery life, and/or environmental conditions (e.g., a temperature, wind speed, or pressure reading). In certain examples, the graphical user interface 124 can present an active display element that can update in real time (e.g., in response to changes in environmental conditions). The active display element can include a ballistic solution, such as an effective distance to a target (discussed more below in relation to FIG. 2). Additionally or alternatively, the ballistic solution can be an angular solution in which ballistic drop compensation is represented in angle terms. In these or other examples, the graphical user interface 124 can overlay a live view that is viewable through the eyepiece 110. Alternatively, the graphical user interface 124 can be partitioned from the live view (e.g., residing in a top region, bottom region, and/or side region) in position adjacent to the live view, but not overlapping the live view.

The first optic device 102 can optionally include sensors 142 (as can any of the first optic device 102, the second optic device 104, and/or the client device 106). In some examples, the sensors 142 can include onboard sensors (e.g., a sensor array or sensor chip that can detect real time environmental conditions). Examples of such sensors can include a pressure sensor, temperature sensor, humidity sensor, bullet speed sensor, altimeter, wind sensor, gyroscope, accelerometer, high G accelerometer or impact sensor (e.g., shock sensor), inertial measurement unit, magnetometer, global positioning system sensor, etc. These and/or other sensors can be utilized in creating the first ballistic profile 118 and the second ballistic profile 120 (as will be discussed below). For instance, in one example, a shock sensor can be used to detect impact trauma to the optic device. In certain instances, the optic device may recommend and/or require that a new ballistic profile be created due to the potential (albeit unintended) change in mechanical zero.

In addition, the first optic device 102 can include an input element 144 receptive to user input. Via the input element 144, a user can provide one or more user inputs to control operation of the optic device (e.g., select, share, edit, upload, download, access, etc. the first ballistic profile 118 and the second ballistic profile 120). In particular examples, the processor 114 can manipulate the display 122, including one or more display elements depicted via the graphical user interface 124. The input element 144 can include, for example, at least one of a button, switch, toggle, dial, slider, touch pad, track pad, joystick, directional pad, etc. Additionally or alternatively, the input element 144 can include capacitance sensing devices, Hall-Effect sensors, proximity sensors, ambient light sensors, etc. (e.g., to aid input detection).

The second optic device 104 can also include a variety of optic devices. In some examples, the second optic device 104 is the same as or similar to the first optic device 102. In particular examples, the second optic device 104 can include a scope mountable to a firearm. A firearm can include a rifle or other weapon capable of expelling a projectile (e.g., a bullet, ball, pellet, etc.) through a barrel by the force of an explosion or other form of combustion. Thus, in some examples, a firearm can include a rifle, muzzleloader, pistol, etc. In certain implementations, a firearm can include weapons where a projectile is expelled through a barrel by pneumatic force. For instance, the firearm can include an air gun, air rifle, pellet gun, paintball gun, etc. Alternatively, a firearm can include other types of weapons, including a crossbow configured to fire an arrow as a projectile.

The second optic device 104 can include a variety of different types of scopes. In some examples, the scope includes light-based scopes that capture light through various lenses (e.g., lenses 130) to magnify a downfield target. In other examples, the scope includes image-based scopes that do not rely on ambient light for providing a magnified field of view. In particular, an imaging scope can use thermal sensors and/or infrared sensors to detect a heat signature emitted by and/or infrared waves corresponding to a target to generate a live image (e.g., a rendered thermal image or rendered infrared image) for display to a user through the imaging scope. Additionally or alternatively, the imaging scope can include night vision sensors (e.g., a charge-coupled device sensor or a complementary metal-oxide semiconductor sensor) to convert available night-time light or photons—typically from starlight and night sky illumination called atmospheric nightglow—into electrons. Other sensors for digital night vision can also be utilized, including various sensors to capture existing ambient light or supplemental infrared light and amplify the captured light (e.g., optoelectronic image enhancement sensors). Still, other sensors for other night vision systems can be utilized, including sensors for shortwave infrared (SWIR) illumination, midwave infrared (MWIR) illumination, longwave infrared (LWIR) illumination. Analog night-vision devices/sensors (e.g., analog image intensifier tubes) can also be utilized in some implementations. In these or other aspects, an imaging scope can be implemented in dark or low-light environments (e.g., involving military operations or hunting at night).

In particular examples, the second optic device 104 can include turrets 126. The turrets 126, for example, can include an elevation turret, a windage turret, and/or a parallax turret. In some examples, at least one of the turrets 126 can include fixed or permanent markings (e.g., custom markings, laser etched markings) for incrementally adjusting the turrets as desired. In certain embodiments, at least one of the turrets 126 includes an electronic display. The electronic display can include an e-ink interface. Additionally or alternatively, the electronic display includes a light emitting diode (LED) display, quantum LED (QLED) display, organic LED (OLED) display, liquid crystal display, digital light processing display, plasma panel display, rear-projection display, a micro display, etc. In one or more aspects, the electronic display includes a graphical user interface with compatibility to software application programming. As a graphical user interface, the electronic display can provide users the capability to intuitively operate the turret, communicate with an external device (e.g., the client device 106), etc. through manipulation of the electronic display and/or elements coupled to the electronic display (e.g., an actuator or encoder). In certain implementations, the electronic display can present ballistic profiles, distance compensation data, environmental conditions, turret settings, data received from an external device, etc.

In some examples, the turrets 126 can include a rotatable element of a scope configured to adjust an optical assembly (e.g., an erector tube with one or more lenses—such as lenses 130, optical elements, and an aiming reticle). In particular examples, a scope turret can include encoder assemblies that are tuned to convert rotational inputs to pixel adjustments of a display 136 viewable through an eyepiece 128. For instance, adjusting an elevation turret can cause a reticle displayed through the eyepiece 128 to move up or down. In certain examples, adjusting the elevation turret can cause a live image displayed through the eyepiece 128 to move up or down. Thus, as a turret is twisted or rotated about an axis of rotation, a line of sight for the second optic device 104 can be correspondingly adjusted.

In some embodiments, the twist or rotation of a turret adjusts the optical assembly by a certain amount. For example, in some embodiments, a full revolution of a turret (e.g., the elevation turret) can equate to an adjustment of the optical assembly from about twelve minutes of angle adjustment to about forty minutes of angle adjustment. In particular embodiments, a full revolution of a turret equates to about twenty minutes of angle adjustment. Still, in other embodiments, a full revolution equates to a different minute of angle adjustment (or a different increment of adjustment all together, such as milliradians).

As used herein, the terms “minute of angle” or “MOA” refer to an angular measurement. In particular, one minute of angle equates to 1/60th of a degree. A MOA adjustment on a turret can correlate to a particular change in location of projectile impact. For example, in relation to elevation, one MOA adjustment via the elevation turret of the turrets 126 equates to about a one-inch elevation change (i.e., 1.047 inches) in impact at 100 yards, about a two-inch elevation change in impact at 200 yards, and so forth.

Similarly, as used herein, the terms “milliradians,” “mils,” or “MRADS” refer to an SI derived unit of angular measurement. In particular, one mil equates to a thousandth of a radian (i.e., 0.001 radian). A mil adjustment of a turret can likewise correlate to a particular change in location of projectile impact. For example, one milliradian equates to a one-meter elevation change in impact at 1000 meters.

As will be discussed below, in some examples, the turrets 126 can include a pre-configured ballistic turret. A pre-configured ballistic turret can include a ballistic data ring having custom markings (e.g., permanent or fixed markings) that are etched, machined, leached, bonded, or otherwise marked or affixed to the turrets 126. The custom markings on the turrets 126 can correspond to highly specific increments of rotational input that are tied to a known adjustment given a specific set of inputs for environmental conditions, firearm data, ammunition data, and firearm configuration. These markings on the turrets 126, in some examples, are established at the time of manufacturing or assembly—not as an end-user task to be changed or created.

The lenses 130 can be the same as or similar to the lenses 112. In some examples, the lenses 130 include one or more ocular lenses at or near the eyepiece 128 and one or more objective lenses at or near an end portion of the second optic device 104 opposite the eyepiece 128.

The processor 132, memory 134, display 136, and input element 146 can be respectively the same as or similar to the processor 114, the memory 116, the display 122, and the input element 144 discussed above.

Furthermore, modifications, omissions, or additions to the second optic device 104 are herein contemplated. For example, those of ordinary skill in the art, having the benefit of this disclosure, will recognize that the second optic device 104 need not be mountable to a firearm. The second optic device 104 can, instead, be mounted to a helmet (e.g., a tactical helmet), a vehicle (e.g., a weaponized vehicle), an aircraft, a drone, a boat, etc. In such examples, the second optic device 104 may not include one or more of the foregoing components, such as the turrets 126.

The system environment 100 can additionally include the client device 106. The client device 106 can include virtually any type of computing device. In some examples, the client device 106 can include a smart phone, radio, notebook computer, desktop computer, tablet, wearable, watch, head-mountable device, audio device (e.g., ear buds, headphones, ear muffs), server, similar devices, and combinations thereof. In some examples, the client device 106 can an external sensor device, such as a chest-worn heart rate sensor, weather meter (e.g., a KESTREL® weather meter), handheld GPS unit, etc. In certain implementations, the client device 106 can be part of a vehicle system (e.g., an airplane, helicopter, truck, boat, drone, tank, etc.).

As shown, the client device 106 can include a client application 140. The client application 140 can include a web application, a native application installed on the client device 106 (e.g., a portable device application, mobile device application, wearable device application, plug-in application, etc.), or a cloud-based application where at least part of the system functionality is performed by one or more servers. In particular examples, the client application 140 can include a user interface responsive to user inputs (e.g., a tap, touch, hold, scroll, slide, pinch, etc.) to perform certain user interface operations. In some examples, the client application 140 can be utilized to generate, modify, share, or otherwise manage the first ballistic profile 118 and the second ballistic profile 120. For instance, the client application 140 can include a profile manager (e.g., with an array of input fields to generate a ballistic profile). The client application 140 can also include other features, such as a ballistic calculator, a ballistic data table, a map feature, a weather station feature, a device manager, a calibration feature, a shooting log feature, etc. In some examples, the client application 140 can utilize sensor data from the sensors 142 (e.g., to determine environmental conditions, obtain location data, and the like).

In these or other examples, the first optic device 102, the second optic device 104, and the client device 106 can be communicatively coupled to each other (individually or in combination) via a network 108. The network 108, depending on the type of network, can facilitate many different types of network connections and/or network communications across devices of the system environment 100. For example, the network 108 can facilitate one or more of a wireless local area network communication, wireless area network communication, wireless personal area network communication, wide area network communication, etc. Some particular examples of wireless communication include a Wi-Fi based communication, mesh network communication, BLUETOOTH® communication, near-field communication, low-energy communication, Zigbee communication, Z-wave communication, HexSPI communication, and 6LoWPAN communication. Other forms of communication include wired connections, such as a USB connection, UART connection, USART connection, I2C connection, SPI connection, QSPI connection, controller area network (CAN) connection, I3C connection, OCTOSPI connection, SMBUS connection, 1-wire connection, etc.

To illustrate, the first ballistic profile 118 and the second ballistic profile 120 can be generated and stored on the client device 106 via the client application 140. In turn, the client device 106 can transmit the first ballistic profile 118 and the second ballistic profile 120 to the first optic device 102 and the second optic device 104 over the network 108. For example, the client device 106 can send the first ballistic profile 118 and the second ballistic profile 120 via a BLUETOOTH® upload to the first optic device 102 and the second optic device 104. As another example, and in the case of a web-based (or cloud-based) version of the client application 140, the first optic device 102 and/or the second optic device 104 can use an internet connection (e.g., Wi-Fi) to access the client application 140 and download the first ballistic profile 118 and the second ballistic profile 120.

Additionally or alternatively, other data can be transmitted between devices of the system environment 100 via the network 108. For example, the client device 106 can relay real time environmental conditions (e.g., weather data representative of shooting conditions), position data, etc. to at least one of the first optic device 102 or the second optic device 104.

In some examples, although not shown, the system environment 100 can include one or more third-party servers communicatively coupled to components of the system environment 100. The third-party server(s) can include a content server and/or a data collection server. Additionally or alternatively, the third-party server(s) can include an application server, a communication server, a web-hosting server, a social networking server, or a digital content management server. In specific implementations, the third-party server(s) can include a messaging server, GPS or satellite server, weather service server, RSS (really simple syndication) data feed server, etc. For example, the third-party server(s) can include a cloud-based (or internet based) weather server providing real-time weather data monitoring for locations throughout the world. In these or other examples, the first optic device 102, the second optic device 104, and/or the client device 106 can retrieve data from the third-party server(s) to perform various method steps disclosed herein.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

As mentioned above, the present disclosure includes optic devices that can store multiple ballistic profiles and dynamically switch between them. FIG. 2 illustrates a schematic view of a ballistic profile 202 used to generate a ballistic solution 212 in accordance with one or more examples of the present disclosure. The ballistic profile 202 can be the same as or similar to the first ballistic profile 118 and the second ballistic profile 120 discussed above in relation to FIG. 1. The ballistic profile 202 can generally include one of two types of profiles—a zero range ballistic profile or a zero angle ballistic profile.

A zero range ballistic profile can include the combination of settings and configurations that establish—for a known distance away from the firearm—an intersection of a projectile trajectory and the line of sight (i.e., the scope axis) for the optic device. Under the zero range ballistic profile, that known distance where the projectile trajectory crosses the line of sight is the “zero range distance” (or “zero range”). For example, at a zero range distance established at 200 yards, the bullet will cross the line of sight (e.g., at the reticle crosshairs) for the optic device at exactly 200 yards away. If reticle crosshairs are positioned on a target positioned 200 yards away, the bullet will strike the target. Once a mechanical zero of the optic device is set according to a zero range ballistic profile, that zero range ballistic profile will, going forward, assume that the projectile trajectory will intersect the line of sight at the zero range and make farther trajectory projections based on that baseline assumption. That is, under the zero range ballistic profile, future ballistic solutions are typically based on trajectory calculations that do not account for (i.e., make ballistic corrections for) the shooting conditions that existed at the time of zeroing the optic device or establishing a mechanical zero—which shooting conditions are otherwise referred to as the zeroing conditions. Said in different terms, the zeroing conditions are effectively ignored under many zero range ballistic profiles. In certain examples, however, a zero range ballistic profile can implement a correction factor in lieu of accounting for the zeroing conditions. The correction factor, in some examples, can reduce or mitigate a magnitude of error propagation that increases with distance downrange.

Conversely, a zero angle ballistic profile can include the combination of settings and configurations—along with the zeroing conditions and the point of target impact relative to a point of aim—that determine the angular relationship between the line of sight for the optic device and the line of departure (e.g., the firearm barrel's longitudinal center axis). The calculated angle between the line of sight for the optic device and the line of departure is referred to as the “zero angle.” Once the zero angle is calculated, there is an inherent, built-in correction for the zeroing conditions because the zeroing conditions were used to calculate the zero angle. Thus, as long as no mechanical adjustments or re-zeroing of the optic device occurs, the zero angle ballistic profile and associated zero angle can be used for accurately calculating a ballistic solution in any future environmental (i.e., weather) condition.

As will now be discussed below, though, the ballistic profile 202 can include certain elements that are generated at the time of profile creation—namely environmental conditions 204, firearm data 206, ammunition data 208, and firearm configuration 210. These elements of the ballistic profile 202 can be initially generated in various ways. In some examples, a user can provide user input or manual entries to complete the ballistic profile 202 (e.g., as a result of user setup, selection, editing, entry, toggling, etc.). The ballistic profile 202 can be created with the aid of shooting data, shooting tests, initial zeroing conditions, device sensors, etc. Additionally or alternatively, the ballistic profile 202 can include automatically generated data (e.g., as a result of default options, sensor data or sensor detection, or predictive software based on a machine learning model, generative model, computational algorithm, data representation, etc.). In some examples, the ballistic profile 202 is at least partially filled out automatically via a setup wizard process that can guide profile setup.

As shown, the environmental conditions 204 is depicted in dashed lines—indicative of being optional. That is, some ballistic profiles like the zero range ballistic profile do not necessarily include or account for the environmental conditions 204 that existed at the time of zeroing the optic device. Environmental conditions can also be referred to as weather conditions, shooting conditions, or conditions (including conditions for a given moment in time, such as at the time of shooting or creating a ballistic profile). Environmental conditions or shooting conditions can refer to ambient conditions of the ambient environment surrounding the optic device. Additionally or alternatively, environmental conditions can describe the optic device in relation to the ambient environment. In particular examples, the environmental conditions 204 can include at least one of an altitude, humidity, temperature, barometric pressure, air density, azimuth, incline, compass heading, wind speed and direction, amount of ambient light (e.g., illuminance or irradiance), latitude/longitude location, etc. The environmental conditions 204 can be sensed and/or measured via one or more sensors (e.g., the sensors 142 discussed above). Additionally or alternatively, the environmental conditions 204 can be retrieved from one or more third-party servers (e.g., weather data servers, weather forecasts, estimated weather conditions, etc.). In these or other examples, the environmental conditions 204 can include shooting conditions represented by weather data of any type, particularly for the time of shooting or creating a ballistic profile.

The firearm data 206 can include a variety of information corresponding to a particular firearm. For example, the firearm data 206 can include a caliber of the firearm—indicating a diameter of the barrel bore or a diameter of the associated ammunition for that firearm. As other examples, the firearm data 206 can include a barrel length (e.g., measured from breech end to muzzle end), a barrel twist rate (e.g., the ratio of inches of bullet travel down the barrel needed to rotate the projectile one full turn), and/or a twist direction (e.g., the corresponding direction of induced bullet rotation from the clockwise or counterclockwise rotation of the rifling).

The ammunition data 208 can include a variety of information corresponding to the specific ammunition to be used in the firearm. For example, the ammunition data 208 can include at least one of a muzzle velocity (e.g., departure speed of bullet once exited the barrel, often measured via a ballistic chronograph), a bullet weight (e.g., a grain value), a bullet length, or a ballistic coefficient (e.g., indicative of a bullet's in-flight ability to overcome air resistance and can be modeled in various ways, such as with a G1 or G7 model, a doppler curve model, etc.). Other examples of the ammunition data 208 can include a powder factor (e.g., a correction factor for muzzle velocity, which correction factor can be expressed in terms of how the muzzle velocity changes for a unit of temperature change), a powder name or manufacturer, a drag function, a chronographer distance relative to the barrel opening of the muzzle end, etc.

The firearm configuration 210 can include a variety of information corresponding to a setup of the firearm itself and/or a shooting setup in which the firearm is/will be shot. In some examples, the firearm configuration 210 includes binary information (e.g., to indicate the presence or non-presence of a given setup). In certain examples, however, the firearm configuration 210 can include numerical values, for instance. To illustrate, the firearm configuration 210 can include a binary indication of a suppressor (e.g., a muzzle device that can mitigate at least one of the audible sound of a gunshot or recoil) or a binary indication of a support stand (e.g., a bi-pod, tri-pod, shooting rest, bean bag, shooting stick, etc.). The firearm configuration 210 can additionally or alternatively include a firearm weight (e.g., a total weight of the firearm), a scope height (e.g., a distance from the central longitudinal axis of the receiver to the central longitudinal axis of the scope), etc.

In specific implementations, the firearm configuration 210 (and/or the firearm data 206) can include zeroing data regarding the firearm setup and shot performance at the time of zeroing the optic device. For example, the zeroing data can include a muzzle velocity, a zero range, a scope height, a shooting azimuth (e.g., the horizontal angle of measure relative to a true north compass heading), a shooting angle (e.g., the angle of inclination measured relative to a horizontal plane), an elevation zero offset (e.g., the vertical distance above/below target at the zero range, such as +1.0 inches at 200 yards), a windage zero offset (e.g., the horizontal distance laterally to the left or right of target at the zero range, such as −0.5 inches at 200 yards), etc.

In at least one example, the firearm configuration 210 (or other aspect of the ballistic profile 202) can include information regarding a ballistic data ring installed with the scope turret at the time of manufacturing. If a ballistic data ring is selected, the ballistic profile will inherently be a zero range ballistic profile, according to some examples. Additional turret information can correspond to the ballistic data ring. In some examples, environmental information can be provided as corresponding to the ballistic data ring (which may be the same as or similar to the environmental conditions 204 discussed above).

After the ballistic profile 202 is created, the ballistic profile 202 can be saved and stored on the client device 106, saved on a third-party cloud server, and/or transmitted to at least one of the first optic device 102 or the second optic device 104 for local device storage. In these or other examples, a client device or optic device can use the ballistic profile 202 to generate a ballistic solution 212 based on input data 200 (e.g., new, dynamic, or changing inputs). The input data 200 can be sensed (e.g., detected via one or more sensors), manually input, or automatically entered. The input data 200 can include a variety of information that corresponds to the real time shooting environment and in-the-field situational circumstances (e.g., post-zeroing of the optic device). Additionally or alternatively, the input data 200 can include firearm adjustments, ammunition adjustments, projected weather conditions, etc. —virtually any data regarding environmental conditions, firearm data, ammunition data, firearm configuration, etc. In particular examples, the input data 200 can include various information about the relative positioning of the target from the shooter (e.g., a target distance, relative angle of inclination, compass heading, etc.).

If the input data 200 exactly matches the data of the ballistic profile 202 (e.g., that existed at the time of profile creation or zeroing the optic device), then the ballistic solution 212 will match the ballistic solution that existed at the zeroing moment. However, the input data 200 can (and likely will) vary from the zeroing conditions because the real time shooting environment and in-the-field situational circumstances are unlikely to exactly match the zeroing conditions. The variation in the input data 200 relative to the ballistic profile 202 thus drives what the ballistic solution 212 will be. In some examples, the input data 200 can include certain shooting parameters that, although different from the ballistic profile 202, can be accurately accounted for in the ballistic solution 212. For example, a target positioned at 800 yards away instead of the zero range at 200 yards can be accounted for in the ballistic solution 212 using the ballistic profile 202 (e.g., because the projectile will still approximate the same calculated flight trajectory at the time of the zeroing conditions). Other input data can also be accounted for, corrected for, or estimated (e.g., built into) the ballistic solution 212.

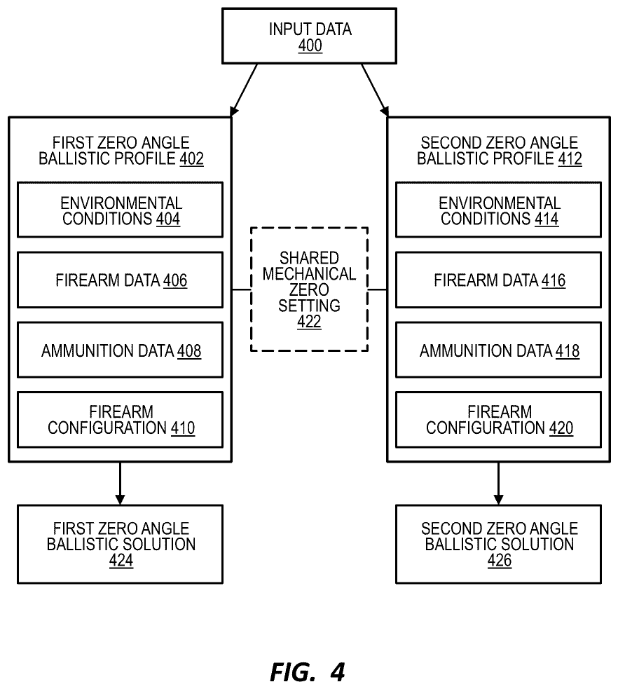

In certain examples, however, the input data 200 cannot always be accounted for in the ballistic solution 212 via the ballistic profile 202. For instance, input data 200 that induces a different projectile trajectory, different flight characteristics, different muzzle velocity, etc. are not going to be fully reflected in the ballistic solution 212 because the projectile is going to take a different flight path than the flight path for the zeroing conditions. In some instances, the input data 200 can be significantly different than the assumed data of the ballistic profile 202, thus inducing larger shot errors at increasingly significant magnitudes at farther ranges. These and other scenarios are discussed below in relation to FIGS. 3-4.

As used herein, the term “ballistic solution” can refer to a calculated or estimated ballistic value describing where (and/or with what settings or parameters) intersection will occur for a projectile path and a line of sight for the optic device. In some examples, the ballistic solution 212 includes an effective distance to target 214 (e.g., a ballistic drop compensation value or shoot-to-range) in terms of yards or meters that builds into that distance value an amount of projected bullet drop—allowing users to quickly and easily turn the scope turret until the effective distance in the scope display matches a ranged distance value on their rangefinder or other optic device. Additionally or alternatively, the ballistic solution 212 can include an angular value or angle adjustment (e.g., in terms of MOA or MILs for corresponding turret adjustment) that is calculated to align—on target—the projectile path and the line of sight for the optics device. In particular examples, a ballistic solution is an algorithmic ballistic solution, a ballistic data table entry, an interpolation value, an approximation value, etc.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2.

As mentioned above, the real time shooting environment, the in-the-field situational circumstances, the shooting equipment used, etc. can change post-zeroing of the optic device. These conditions can significantly affect the accuracy of a ballistic solution. Thus, the present disclosure includes optic devices that can store and implement multiple ballistic profiles—one of which includes a newly created ballistic profile custom tailored to the changed circumstances, new conditions, alternate shooting setup, etc. In accordance with one or more such examples of the present disclosure, FIG. 3 illustrates a specific schematic implementation of using a zero-angle ballistic profile in conjunction with a pre-configured ballistic turret that is associated with a zero range ballistic profile.

In more detail, input data 300 (which can be the same as or similar to the input data 200 discussed above) may include data representative of a real time shooting environment, in-the-field situational circumstances, shooting equipment used, positional data, shooting angle, distance from target, etc. The input data 300 may not be similar to (and indeed may be drastically different from) the data composing a zero range ballistic profile 302. The zero range ballistic profile 302 can be the same as or similar to at least one of the first ballistic profile 118, the second ballistic profile 120, or the ballistic profile 202 discussed above. In particular examples, the zero range ballistic profile 302 is the ballistic profile created during the manufacturing process for a pre-configured ballistic turret 326 (e.g., a scope turret including a ballistic data ring or other portions having custom markings 328). The custom markings 328 correspond to a zero range distance and precisely account for bullet drop along the flight path at incremental distances extending beyond the zero range. As a result, the custom markings 328 is accurately tailored for providing a predetermined adjustment via the pre-configured ballistic turret 326, which adjustment is indicated by a zero range ballistic solution 324. In these or other examples, the zero range ballistic solution 324 assumes the input data 300 matches the initial zeroing conditions (i.e., the environmental conditions 304, firearm data 306, ammunition data 308, and firearm configuration 310) outlined in the zero range ballistic profile 302 when the pre-configured ballistic turret 326 was manufactured and calibrated.

The input data 300 in most cases is not, however, constantly aligned with or a perfect match to the initial zeroing conditions outlined in the zero range ballistic profile 302. The present disclosure, thus, discusses implementing a new or modified ballistic profile (e.g., a zero angle ballistic profile) in addition to the zero range ballistic profile 302, which new ballistic profile can account for the new conditions or variations represented by the input data 300. In turn, one or more system components of the system environment 100 can relate (e.g., convert, translate, adapt, transform, interpret) ballistic solutions for the new ballistic profile in terms of the custom markings 328 of the pre-configured ballistic turret 326.

To illustrate, the input data 300 can be utilized to generate a zero angle ballistic profile 312. The zero angle ballistic profile 312 can be the same as or similar to at least one of the first ballistic profile 118, the second ballistic profile 120, or the ballistic profile 202 discussed above. In particular examples, however, at least one of the environmental conditions 314, the firearm data 316, the ammunition data 318, and/or the firearm configuration 320 can respectively differ from the environmental conditions 304, the firearm data 306, the ammunition data 308, and/or the firearm configuration 310. The zero angle ballistic profile 312—specifically the environmental conditions 314—can thus capture extreme shifts in environmental conditions relative to the environmental conditions 304 (e.g., when hunting in a different state or even with significant elevation change on a mountain for instance). In another example, the zero angle ballistic profile 312—specifically the ammunition data 318—can account for the ballistic parameters of copper, lead-free bullets as opposed to ballistic parameters for a lead-based bullet captured in the ammunition data 308. In yet another example, the zero angle ballistic profile 312—specifically the firearm configuration 320—can account for implementation of a suppressor when the firearm configuration 310 did not. Still, in another example, the zero angle ballistic profile 312 (e.g., the firearm data 316, the ammunition data 318, or the firearm configuration 320) can account for a changed muzzle velocity from barrel wear over time. Many other scenarios of a real time shooting environment, in-the-field situational circumstance, shooting equipment used, etc. can be accurately accounted for in the zero angle ballistic profile 312 (or other new ballistic profile).

To generate the zero angle ballistic profile 312, the user does not re-zero the optic device. That is, the zero range ballistic profile 302 and the zero angle ballistic profile 312 can include (or assume) a shared mechanical zero setting 322. By having the shared mechanical zero setting 322, a user can generate the zero angle ballistic profile 312 without performing a time consuming (and inconvenient) process of finding a new zero range, loosening turret covers or housings to adjusting turret stops or turret zero markings, etc. In other terms, the positioning of an optical assembly (e.g., the erector tube of a scope) is maintained at the zero position without any mechanical adjustments.

Instead, a system component of FIG. 1 can relate the zero angle ballistic profile 312 to the zero range ballistic profile 302. This can be achieved in a variety of ways. In particular examples, relating the zero angle ballistic profile 312 to the zero range ballistic profile 302 can include identifying a point of impact differential 330. The point of impact differential 330 can include an elevation zero offset (e.g., the +/−measurement above or below the point of aim at the zero range distance). Additionally or alternatively, the point of impact differential 330 can include a windage zero offset (e.g., the +/−measurement right or left of the point of aim at the zero range distance). These offset values or measurements for determining the point of impact differential 330 can be achieved in just a few rounds (e.g., by firing 2-5 bullets in the new shooting environment at a target positioned at the zero range distance and averaging the point of aim versus point of impact differences).

From the point of impact differential 330, one or more system components can then determine what the zero angle is for that firearm given the conditions/shooting setup etc. represented by the input data 300 and accounted for in the zero angle ballistic profile 312. That zero angle can, in turn, drive a calculation for determining a zero angle ballistic solution 332.

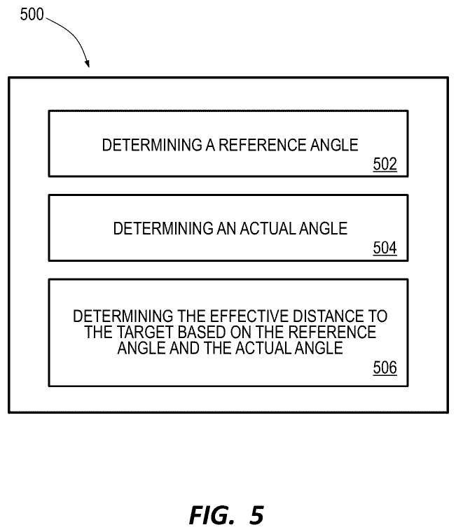

In one or more examples, the zero angle ballistic solution 332 can include an effective distance to target (e.g., the ballistic drop compensation value or shoot-to-range). In specific examples, the zero angle ballistic solution 332 is displayed in relation to the custom markings 328 on the pre-configured ballistic turret 326 so that a user can quickly and easily turn to that value on the pre-configured ballistic turret 326. Even though the custom markings 328 were calibrated based on the data for the zero range ballistic profile 302 that existed at the time and environment of manufacturing, the zero angle ballistic solution 332 includes a built-in conversion because the zero angle ballistic profile 312 is ballistically related to the zero range ballistic profile 302 by way of at least the point of impact differential 330. In this manner, a user need not deal with any conversion of a distance value (or angular adjustment value) for the zero angle ballistic solution 332. The zero angle ballistic solution 332 has this conversion already built in or translated to read in terms of the values represented by the custom markings 328. Additional detail of determining the zero angle ballistic solution 332 is discussed in further detail below in relation to FIG. 5.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

As mentioned above, the present disclosure includes implementations involving multiple ballistic profiles (whether multiple zero range ballistic profiles, multiple zero angle ballistic profiles, or combinations thereof). FIG. 4 illustrates an example schematic implementation including multiple zero angle ballistic profiles in accordance with one or more examples of the present disclosure.

As shown in FIG. 4, a first zero angle ballistic profile 402 can include environmental conditions 404, firearm data 406, ammunition data 408, and firearm configuration 410. Similarly, a second zero angle ballistic profile 412 can include environmental conditions 414, firearm data 416, ammunition data 418, and firearm configuration 420. The first zero angle ballistic profile 402 and the second zero angle ballistic profile 412 can be the same as or similar to the first ballistic profile 118, the second ballistic profile 120, the ballistic profile 202, and/or the zero angle ballistic profile 312 discussed above. In at least some examples, the first zero angle ballistic profile 402 and the second zero angle ballistic profile 412 differ by at least one of their constituent components (whether environmental conditions, firearm data, ammunition data, firearm configuration, or a combination thereof). Both of the first zero angle ballistic profile 402 and the second zero angle ballistic profile 412 can be simultaneously stored on an optic device (or other system component discussed in FIG. 1) and readily selected for use.

In one or more examples, a user can select the first zero angle ballistic profile 402 or the second zero angle ballistic profile 412 based on input data 400 (e.g., data representative of a real time shooting environment, in-the-field situational circumstances, shooting equipment used, positional data, shooting angle, distance from target, etc.). For instance, if a user is shooting a 7 mm caliber rifle that day, the user could select the first zero angle ballistic profile 402 corresponding to that firearm and associated setup. Later, if the user switches to another caliber rifle (e.g., a 30-06 caliber), the user can select the operable ballistic profile for an optic device to be the second zero angle ballistic profile 412 corresponding to that different firearm and associated setup. Myriad other configurations and arrangements for the first zero angle ballistic profile 402 and the second zero angle ballistic profile 412 are herein contemplated. Indeed, in some examples, and as indicated via a shared mechanical zero setting 422, the first zero angle ballistic profile 402 and the second zero angle ballistic profile 412 can correspond to a same firearm and scope setup, but differ by the ammunition used, a suppressor integration, etc. Thus, the first zero angle ballistic profile 402 and the second zero angle ballistic profile 412 (and/or other ballistic profiles) can be conveniently selected in a matter of seconds for the desired implementation best fitting the input data 400.

In these or other examples, the first zero angle ballistic profile 402 can generate a first zero angle ballistic solution 424, and the second zero angle ballistic profile 412 can generate a second zero angle ballistic solution 426 that differs from the first zero angle ballistic solution 424. Thus, for a same set of input conditions (e.g., ranged distance to target, shooting angle, etc.) represented by the input data 400, the same optic device can generate entirely different ballistic solutions depending on which ballistic profile is selected. Unlike existing optic devices storable with just a single ballistic profile, the present disclosure enables a whole new level of flexibility and customization heretofore unachieved by storing multiple ballistic profiles on an optic device and allowing convenient profile switching directly within the optic device.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

FIGS. 1-4, the corresponding text, and the examples provide several different systems, methods, techniques, components, and/or devices of a system environment with optic devices in accordance with one or more embodiments. In addition to the above description, one or more embodiments can also be described in terms of flowcharts including acts for accomplishing a particular result or performing a certain function. For example, FIG. 5 illustrates a flowchart of a series of acts 500 for determining a zero angle ballistic solution in accordance with one or more embodiments of the present disclosure. One or more examples of an optic device and/or a client device (e.g., the first optic device 102, the second optic device 104, and/or the client device 106) may perform one or more acts of the series of acts 500 in addition to or alternatively to one or more acts described in conjunction with other figures. While FIG. 5 illustrates acts according to one embodiment, alternative embodiments may omit, add to, reorder, and/or modify any of the acts shown in FIG. 5. The acts of FIG. 5 can be performed as part of a method. Alternatively, a non-transitory computer-readable medium can comprise instructions that, when executed by one or more processors, cause a computing device (or a computer component, such as a processor, implemented on a optic device or client device) to perform the acts of FIG. 5. In some embodiments, a system can perform the acts of FIG. 5.

As shown, the series of acts 500 can include an act 502 of determining a reference angle. More particularly, the act 502 can include determining, for the zero range ballistic profile, a reference angle between a line of sight for an optic device and a bore line of the firearm. In these or other examples, the reference angle can position a theoretical projectile path to intersect the line of sight at a reference distance to the target (e.g., the zero range distance, the ranged distance to the target, etc.) for the set of zeroing environmental conditions. The reference angle is, in particular examples, a retroactive zero angle or hypothetical zero angle that is assumed based on the environmental conditions that existed at the time of creating the zero range ballistic profile and associated ballistic data ring. Indeed, the reference angle can be referred to as a back-calculated zero angle based on the then-existing environmental conditions and other profile data of the zero range ballistic profile. Additionally or alternatively, the reference angle can be an estimated zero angle based on known tangent, sine, and/or cosine values (e.g., based on the refence distance and the elevation offset values for points of impact).

The act 504 can include an act of determining an actual angle. Specifically, the act 504 can include determining, for the zero angle ballistic profile, an actual angle between the line of sight and the bore line. In these or other examples, the actual angle can position a projectile path to intersect the line of sight at a ranged distance to the target (e.g., a true distance or measured distance away from the firearm—as the crow flies). The actual angle, in particular examples, can be a current/real time zero angle based on the actual environmental conditions, shooting setup, etc.—as outlined in the zero angle ballistic profile.

The act 506 can include an act of determining the effective distance to the target based on the reference angle and the actual angle. The act 506 can be achieved in various ways. In some examples, determining the effective distance to the target (e.g., the ballistic drop compensated distance value in terms of the pre-configured ballistic turret and associated markings) comprises iteratively modifying the reference distance to the target until the reference angle approximates the actual angle within a threshold value. The threshold value can include a tolerance range of approximation, a certain degree of error, etc.

In these or other examples, iteratively modifying the reference distance to the target until the reference angle approximates the actual angle can be performed in various ways to prioritize and/or balance accuracy versus computation time/processor overhead. In some examples, iteratively modifying the reference distance to the target until the reference angle approximates the actual angle can be done in predetermined step sizes or magnitudes of distance (e.g., in fractional yard increments, 1-yard increments, 5-yard increments, and so forth). In certain examples, iteratively modifying the reference distance to the target until the reference angle approximates the actual angle can include an interpolation process (e.g., interpolating the reference angle and the actual angle). In specific examples, one to four loops of interpolation can accurately approximate the reference angle to the actual angle.

Once approximated, the modified reference distance (which corresponds to the modified reference angle) can be used as the effective distance to the target. More particularly, this effective distance to the target can be shown in terms of yards or meters that a user can quickly and easily turn the scope turret to on their optic device (e.g., using the custom turret markings and/or the heads up display of the optic device). In other terms, determining the zero angle ballistic solution with an effective distance to target can include converting a zero angle ballistic drop compensation value for the zero angle ballistic profile to a turret value found on the custom markings according to the zero range ballistic profile—where the turret value (or ballistic data ring value) can include a distance value represented in yards, meters, or other calibration scale (e.g., a tuned distance value, custom distance value, etc.). Additionally or alternatively, the turret value can include an angle value represented in minutes of angle or milliradians.

Thus, even with an optic device having a pre-configured ballistic turret established with a zero range ballistic profile, the present disclosure can enable a dynamic implementation of an entirely separate zero angle ballistic profile to be used with that optic device and associated pre-configured ballistic turret. The acts discussed above (and/or others in the present disclosure) can ballistically relate two different profiles in a way that allows cross-compatibility, which is heretofore unachieved in the art.

As mentioned above, alternative embodiments may omit, add to, reorder, and/or modify any of the acts shown in FIG. 5. In one such example, determining a zero angle ballistic solution can include estimating a zero angle ballistic solution using one or more data tables. For example, a ballistic data ring can be associated with a data table for a zero range ballistic profile. The data table can include field entries corresponding to a multi-dimensional array (e.g., increments of MOA adjustment per distance to target) precisely suited to the input conditions of the zero range profile. In turn, the zero angle profile can include a known bullet drop (e.g., the actual MOA adjustment for a specific yardage) precisely suited to one or more of the new, different, or changed input conditions of the zero angle profile. Thus, to generate a zero angle ballistic solution in terms of the ballistic data ring, the actual MOA adjustment for the zero angle profile can be inserted into the data table (or otherwise analyzed against the data table values). For instance, via interpolation of the data table MOA angle adjustment values, the actual MOA adjustment can be converted into a ballistic data ring distance value.

The foregoing description, for purposes of explanation, used specific nomenclature to provide a thorough understanding of the described examples. However, it will be apparent to one skilled in the art—having the benefit of this disclosure—that the specific details are not required in order to practice the described examples. Thus, the foregoing descriptions of the specific examples described herein are presented for purposes of illustration and description. They are not intended to be exhaustive or to limit the examples to the precise forms disclosed.

It will be apparent to one of ordinary skill in the art—having the benefit of this disclosure—that many modifications and variations are possible in view of the above teachings. Indeed, various inventions have been described herein with reference to certain specific aspects and examples. However, with the benefit of this disclosure, those skilled in the art will recognize that many variations are possible without departing from the scope and spirit of the inventions disclosed herein. Specifically, those inventions set forth in the claims below are intended to cover all variations and modifications of the inventions disclosed without departing from the spirit of the inventions. The terms “including” or “includes” as used in the specification shall have the same meaning as the term “comprising.”

What is claimed is:

1. A method comprising:
identifying a zero range ballistic profile for use with a pre-configured ballistic turret having custom markings, the pre-configured ballistic turret being pre-configured according to a set of zeroing environmental conditions, a first set of firearm data, a first set of ammunition data, and a first firearm configuration;
identifying a zero angle ballistic profile associated with at least one of:
a set of shooting conditions different than the set of zeroing environmental conditions;
a second set of firearm data different than the first set of firearm data;
a second set of ammunition data different that the first set of ammunition data; or
a second firearm configuration different than the first firearm configuration; and
determining, using the zero angle ballistic profile and the zero range ballistic profile, a zero angle ballistic solution that includes an effective distance to a target in relation to the custom markings on the pre-configured ballistic turret.

2. The method of claim 1, wherein the first firearm configuration or the second firearm configuration differ from each other by at least one of a suppressor, a support stand setup, a firearm weight, or a scope height.

3. The method of claim 1, wherein the first firearm data and the second firearm data differ from each other by at least one of a caliber, a barrel length, a barrel twist rate, or a twist direction.

4. The method of claim 1, wherein the first set of ammunition data and the second set of ammunition data differ from each other by at least one of a muzzle velocity, a bullet weight, a bullet length, or a ballistic coefficient.

5. The method of claim 1, wherein the set of zeroing environmental conditions and set of shooting conditions differ from each other by at least one of elevation, pressure, air density, temperature, humidity, azimuth, incline, or wind conditions.

6. The method of claim 1, wherein determining the zero angle ballistic solution comprises:
determining, for the zero range ballistic profile, a reference angle between a line of sight for an optic device and a bore line of the firearm, wherein the reference angle positions a theoretical projectile path to intersect the line of sight at a reference distance to the target for the set of zeroing environmental conditions;
determining, for the zero angle ballistic profile, an actual angle between the line of sight and the bore line, wherein the actual angle positions a projectile path to intersect the line of sight at a ranged distance to the target; and
determining the effective distance to the target based on the actual angle and the reference angle.

7. The method of claim 6, wherein determining the effective distance to the target comprises iteratively modifying the reference distance to the target until the reference angle approximates the actual angle within a threshold value.

8. The method of claim 6, wherein determining the effective distance to the target comprises interpolating the reference angle and the actual angle.

9. The method of claim 1, wherein determining the zero angle ballistic solution comprises converting a zero angle ballistic drop compensation value for the zero angle ballistic profile to a turret value found on the custom markings according to the zero range ballistic profile, the turret value comprising a distance value represented in yards, meters, or other calibration scale.

10. A system comprising:
a first optic device mountable on a firearm and configurable to a mechanical zero setting;
a client device comprising:
a ballistic profile established for the firearm and the first optic device configured at the mechanical zero setting; and
a modified ballistic profile also established for the firearm and the first optic device configured at the mechanical zero setting, the modified ballistic profile being related to the ballistic profile via at least a point of impact differential; and
a second optic device communicatively coupled to the client device and comprising:
a processor; and
a memory device comprising computer-executable instructions that, when executed by the processor, cause the second optic device to:
receive, via a network connection to the client device, the ballistic profile and the modified ballistic profile;
generate, for display in a graphical user interface, a selection menu comprising the ballistic profile and the modified ballistic profile;
identify a first user input selecting the modified ballistic profile from the selection menu; and
generate, for display in a graphical user interface, a first ballistic solution according to the modified ballistic profile.

11. The system of claim 10, wherein the ballistic profile and the modified ballistic profile are both zero angle ballistic profiles.

12. The system of claim 10, wherein the ballistic profile and the modified ballistic profile both account for respective environmental conditions existing when the ballistic profile and the modified ballistic profile were created.

13. The system of claim 10, wherein:
the first optic device comprises a pre-configured ballistic turret having custom markings; and
the first ballistic solution comprises an effective distance to a target in relation to the custom markings on the pre-configured ballistic turret.

14. The system of claim 10, further comprising computer executable instructions that, when executed by the processor, cause the second optic device to:
identify a second user input within the selection menu to switch from the modified ballistic profile to the ballistic profile; and
generate, for display in the graphical user interface, a second ballistic solution according to the ballistic profile.

15. The system of claim 10, wherein the ballistic profile and the modified ballistic profile differ by at least one of environmental conditions, firearm data, ammunition data, or firearm configuration.

16. The system of claim 10, wherein the point of impact differential comprises a difference in elevation offset values respectively measured for bullet impacts according to the ballistic profile and the modified ballistic profile on a target positioned at a known distance.

17. The system of claim 10, wherein the first optic device comprises:
the ballistic profile and the modified ballistic profile stored thereon;
a turret;
an eyepiece; and
a heads up display viewable through the eyepiece and configured to also display the first ballistic solution according to the modified ballistic profile by dialing the turret until a displayed ballistic solution on the heads up display matches the first ballistic solution.

18. An optic device, comprising:
an eyepiece having a field of view through one or more lenses;
a display element configured to present a graphical user interface viewable through the eyepiece at a position adjacent to or overlaid relative to the field of view;
an input element receptive to user input;
a processor; and
a memory device comprising computer-executable instructions that, when executed by the processor, cause the optic device to:
receive multiple zero angle profiles from a client device;
identify a user input via the input element to select one of the zero angle profiles;
and
generate, for display in the graphical user interface, a ballistic solution according to the selected zero angle profile.

19. The optic device of claim 18, wherein:
the zero angle profiles are configured to generate ballistic solutions for at least one of new environmental conditions, new firearm data, new ammunition data, or a new firearm configuration; and
the ballistic solutions are displayable in terms of custom markings of a pre-configured ballistic turret established according to an original set of zeroing environmental conditions, an original set of firearm data, an original set of ammunition data, and an original firearm configuration.

20. The optic device of claim 18, wherein each of the zero angle profiles assumes a constant mechanical zero setting that is unchanged regardless of which zero angle profile is selected.
